(19) United States
(12) Patent Application Publication
(10) Pub. No.: US 2014/0250472 A1
(43) Pub. Date: Sep. 4, 2014

(54) DIGITAL MEDIA PLAYING SYSTEM

(71) Applicant: Primax Electronics Ltd., Neihu (TW)

(72) Inventors: Sheng-Ling Huang, Neihu (TW); Jung-Chang Yang, Neihu (TW)

(21) Appl. No.: 13/906,002

(22) Filed: May 30, 2013

(30) Foreign Application Priority Data
Mar. 1, 2013 (TW) 102107264

(51) Int. Cl. H04N 21/2383; H04N 21/643

(52) U.S. Cl. CPC H04N 21/2383; H04N 21/643
USPC 725/82

(57) ABSTRACT

A digital media playing system includes a digital media server and a digital media output device. By recording the video and audio data that are played by a video and audio playing device of the digital media server, a video and audio recording file is generated. By performing an encoding operation and a wrapping operation on the video and audio recording file, an identifiable streaming media file is obtained. In addition, the identifiable streaming media file is transmitted to the digital media output device to be played. Consequently, the video and audio data that are played by the video and audio playing device of the digital media server can be outputted through mirroring.

### FIELD OF THE INVENTION

The present invention relates to a digital media playing system, and more particularly to a digital media playing system that complies with a Digital Living Network Alliance (DLNA) protocol.

### BACKGROUND OF THE INVENTION

The Digital Living Network Alliance (DLNA) is an alliance organization that is composed by the manufacturers of consumer electronics products, mobile phones and computers. The DLNA is responsible for defining unified transmission specifications to allow a variety of products from different manufacturers to communicate with each other. Consequently, the video and audio devices that comply with the DLNA protocol can be in direct communication with each other in order to make synchronization actions or even transfer data.

FIGS. 1, 2 and 3 schematically illustrate the architectures of three conventional digital media playing systems. The devices of the digital media playing system 1 under the DLNA environment may be classified into four types, i.e. a digital media server (DMS) 11, a digital media player (DMP) 12, a digital media controller (DMC) 13 and a digital media renderer (DMR) 14.

The digital media server 11 is a device for acquiring, recording or storing a multimedia file 15. The digital media player 12 is used for searching and playing the multimedia file 15 that is provided by the digital media server 11. The digital media controller 13 is used as a remote device for searching the multimedia file 15 from the digital media server 11 and designating the digital media renderer 14 to play the multimedia file 15. The digital media renderer 14 is used for receiving and playing the multimedia file 15 that is transmitted from the digital media server 11.

First of all, please refer to FIG. 1. In case that the digital media server 11 and the digital media player 12 are included in the same network domain, the digital media player 12 may perform the step Si of searching the multimedia files 15 of the digital media server 11 and selecting a specified multimedia file 15. In case that a request from the digital media player 12 is received by the digital media server 11, the digital media server 11 may perform the step S2 of transmitting the specified multimedia file 15 to the digital media player 12. After the specified multimedia file 15 is received by the digital media player 12, the specified multimedia file 15 is played by the digital media player 12.

Then, please refer to FIG. 2. In case that the digital media server 11 and the digital media renderer 14 are included in the same network domain, the digital media server 11 may perform the step S3 of selecting a specified multimedia file 15 from the multimedia files 15 and transmitting the specified multimedia file 15 to the digital media renderer 14. After the specified multimedia file 15 is received by the digital media renderer 14, the specified multimedia file 15 is played by the digital media renderer 14.

Then, please refer to FIG. 3. In case that the digital media server 11, the digital media controller 13 and the digital media renderer 14 are included in the same network domain, the digital media controller 13 may perform the step S4 of searching the multimedia files 15 of the digital media server 11 and selecting a specified multimedia file 15 to be played by the digital media renderer 14. Then, the digital media server 11 performs the step S5 of transmitting the specified multimedia file 15 to the digital media renderer 14. After the specified multimedia file 15 is received by the digital media renderer 14, the specified multimedia file 15 is played by the digital media renderer 14.

As mentioned above, the computers, mobile phones, servers and players that are included in the same network domain and comply with the DLNA protocol may share and play the multimedia contents (e.g. movies, songs, pictures, and the like) through network connection. For example, the user may use a computer in a kitchen to browse and select the movies of a computer in a study room and designate the selected movie to be played by a display screen of a TV in a living room. Consequently, the purposes of conveniently and quickly sharing video and audio data can be achieved.

Generally, the digital media server 11 is only responsible for providing the multimedia file 15 and forwarding the multimedia file 15 to be played by the digital media player 12 or the digital media renderer 14. However, the digital media server 11 fails to output the played image and sound to the digital media player 12 or the digital media renderer 14 through mirroring.

That is, the video and audio data from the video and audio playing device of the digital media server 11 fail to be real-time played by the digital media player 12 or the digital media renderer 14 that complies with the DLNA protocol. For example, if the digital media server 11 is a computer and the user wants to output the contents of operating the computer (e.g. the game screen that is being shown or the movie screen that is being watched) to the TV screen, the user fails to successfully mirror the display screen of the computer to the TV screen.

Nowadays, an “AirPlay” playing technology was developed by Apple Inc. By the “AirPlay” playing technology, the video and audio data played by an AirPlay sender device running the iOS or OS X operating system (e.g. iPhone, iPod touch, iPad or Mac) may be transmitted to an AirPlay receiver device (e.g. an Apple TV) through mirroring. Since the “AirPlay” playing technology is only applied to the products of Apple Inc., it fails to be applied to the products of other manufacturers. Therefore, the applications of this playing technology are limited

For overcoming the above drawbacks, there is a need of providing a digital media playing system with a mirroring function and applied to various products of different manufactures that comply with the DLNA protocol.

### SUMMARY OF THE INVENTION

The present invention provides a digital media playing system for outputting video and audio data that are played by a digital media server through mirroring.

In accordance with an aspect of the present invention, there is provided a method for outputting video and audio data that are played by a digital media server through mirroring. Firstly, the video and audio data that are played by the digital media server are recorded, so that a video and audio recording file is generated. Then, the video and audio recording file is converted into an identifiable streaming media file. Then, the identifiable streaming media file is transmitted to a digital media output device.

In accordance with another aspect of the present invention, there is provided a digital media playing system. The digital media playing system includes a digital media server and a digital media output device. The digital media server is used for playing video and audio data, recording the video and audio as a video and audio recording file and converting the video and audio recording file into an identifiable streaming media file. The digital media output device is used for receiving and playing the identifiable streaming media file.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a first conventional digital media playing system;

FIG. 2 schematically illustrates the architecture of a second conventional digital media playing system;

FIG. 3 schematically illustrates the architecture of a third conventional digital media playing system;

FIG. 4 schematically illustrates the architecture of a digital media playing system according to a first embodiment of the present invention;

FIG. 5 is a flowchart illustrating a method of transmitting video and audio data by the digital media playing system according to the first embodiment and a second embodiment of the present invention;

FIG. 6 schematically illustrates the architecture of a digital media playing system according to the second embodiment of the present invention;

FIG. 7 schematically illustrates the architecture of a digital media playing system according to a third embodiment of the present invention; and

FIG. 8 is a flowchart illustrating a method of transmitting video and audio data by the digital media playing system according to the third embodiment of the present invention.

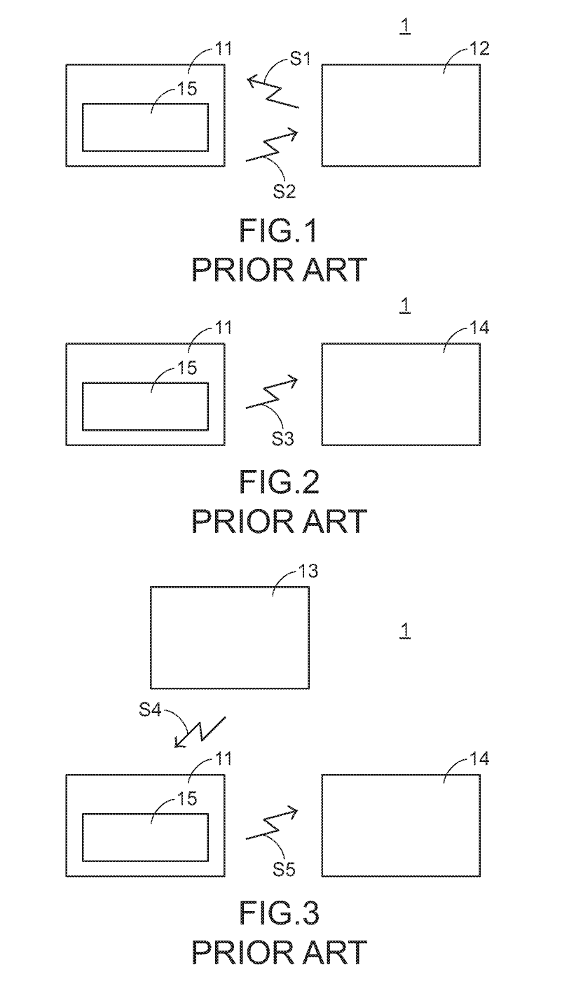

### DETAILED DESCRIPTION OF THE PREFERRED EMBODIMENT

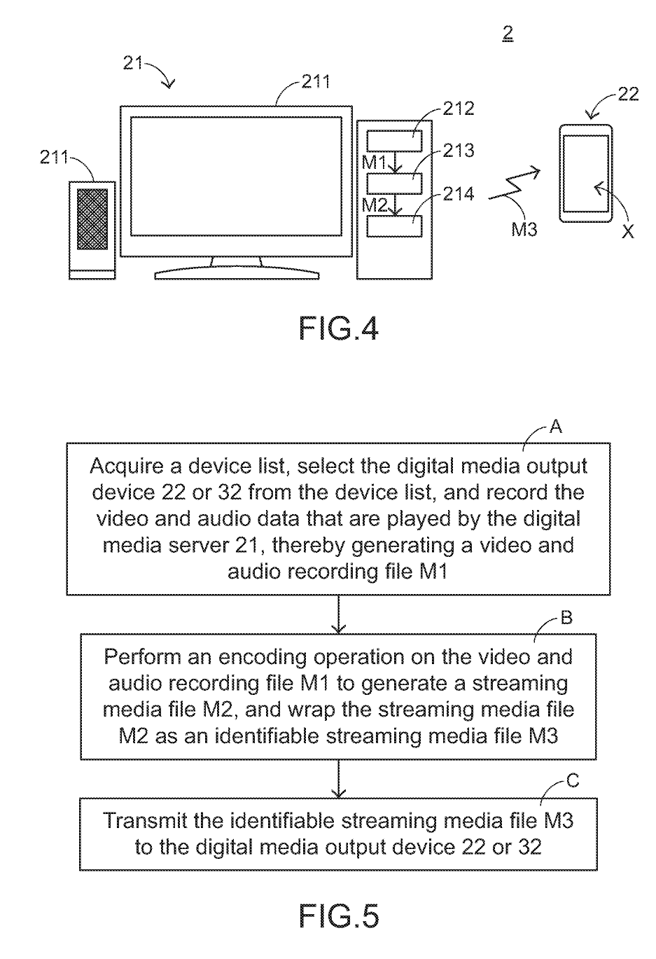

Hereinafter, a digital media playing system 2 according to a first embodiment of the present invention will be illustrated with reference to FIG. 4. FIG. 4 schematically illustrates the architecture of a digital media playing system according to the first embodiment of the present invention. As shown in FIG. 4, the digital media playing system 2 at least comprises a digital media server (DMS) 21 and a digital media output device 22 that comply with the DLNA protocol. In this embodiment, the digital media output device 22 is a digital media player (DMP).

The digital media server 21 is for example a network-attached storage (NAS) device, a computer, a home theater device or a mobile phone that complies with the DLNA protocol. In this embodiment, the digital media server 21 is a NAS device. The digital media output device 22 (i.e. the digital media player) is for example a mobile phone, a TV, a home theater device, a personal digital assistant (PDA), a game console host or a computer that complies with the DLNA protocol. In this embodiment, the digital media output device 22 is a mobile phone. In this embodiment, by operating the digital media output device 22, the video and audio data that are being played by a display screen and a speaker of the NAS device 21 may be selected and outputted to the mobile phone to be played through mirroring. Consequently, the operating screen, the movie screen or the game screen of the NAS device can be synchronously shown on the mobile phone.

Hereinafter, a method of transmitting the video and audio data that are being played by the digital media server 21 to the digital media output device 22 through mirroring will be illustrated with reference to FIGS. 4 and 5. FIG. 5 is a flowchart illustrating a method of transmitting video and audio data by the digital media playing system according to the first embodiment and a second embodiment of the present invention.

As shown in FIGS. 4 and 5, the digital media server 21 comprises a video and audio playing device 211, a video and audio pickup device 212, an encoder 213, and a wrapper 214.

The video and audio playing device 211 includes a video output device and an audio output device. The video output device and the audio output device may be different devices or may be two components of the same device. In this embodiment, the video and audio playing device 211 includes a display screen and a speaker. Alternatively, in some other embodiments, the video and audio playing device 211 is a display screen with a speaker, but is not limited thereto.

The video and audio pickup device 212 may be a recording program running in the digital media server 21 or a physical recording device that is in communication with the digital media server 21. The video and audio pickup device 212 is used for recording the video and audio data that are being played by the video and audio playing device 211. In this embodiment, the video and audio pickup device 212 is a recording program for recording the contents of the display screen and the sound from the speaker. It is noted that the type of the video and audio pickup device 212 is not restricted. That is, any recording program or any physical recording device capable of recording the video and audio data that are being played by the digital media server 21 may be used as the video and audio pickup device 212 of the present invention.

For outputting the video and audio data that are being played by the video and audio playing device 211 of the digital media server 21 through mirroring, the step (A) is firstly performed. In this embodiment, the same video and audio data that are being played by the display screen and the speaker of the NAS device are intended to be played by the mobile phone. Firstly, a user interface X of the digital media output device 22 is acquired. A device list is shown on the user interface X. The device list includes all of the digital media servers 21 and the digital media output devices 22 that are now included in the same network domain and comply with the DLNA protocol. Then, the user may select the specified digital media server 21 and the specified digital media output device 22 from the device list, so that the video and audio data of the digital media server 21 may be outputted to the digital media output device 22 through mirroring.

After the video and audio data of the digital media server 21 are selected to be outputted to the digital media output device 22 through mirroring, the video and audio data that are being played by the video and audio playing device 211 of the digital media server 21 are recorded by the video and audio pickup device 212. In this embodiment, the contents of the display screen and the sound from the speaker are recorded by the video and audio pickup device 212. Moreover, at the time when the video and audio data are recorded by the video and audio pickup device 212, the video and audio pickup device 212 generates a corresponding video and audio recording file M1.

Then, in the step (B), an encoding operation is performed on the video and audio recording file M1 by the encoder 213, so that a streaming media file M2 is generated. The streaming media file M2 may have various possible formats such as H.264, MP3, MPEG4, WMV, WMA, RM, RA, MOV, or the like. It is noted that the above formats of the streaming media file M2 are presented herein for purpose of illustration and description only. That is, the formats of the streaming media file M2 are not restricted.

Then, a wrapping operation is performed on the streaming media file M2 by the wrapper 214, thereby generating an identifiable streaming media file M3. In particular, the identifiable streaming media file M3 is distinguished from the streaming media file M2 because the identifiable streaming media file M3 contains a metadata. The metadata include various messages that can be identified by the digital media output devices 22 complying with the DLNA protocol. Consequently, the identifiable streaming media file M3 can be successfully received by the digital media output devices 22.

Afterwards, the step (C) is performed to transmit the identifiable streaming media file M3 from the digital media server 21 to the digital media output device 22. After the identifiable streaming media file M3 is received by the digital media output devices 22, the identifiable streaming media file M3 starts to be played. Consequently, the image and sound identical to those of the digital media server 21 can be played by the digital media output devices 22 in real time.

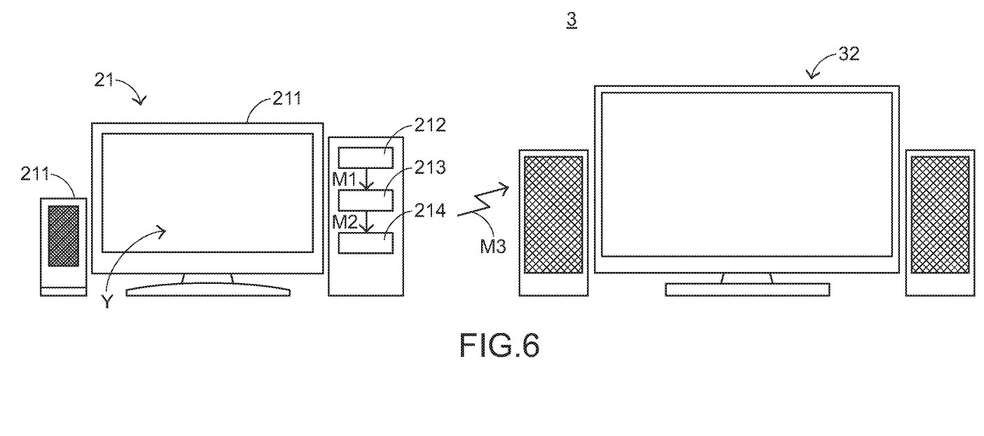

Hereinafter, a digital media playing system 3 according to a second embodiment of the present invention will be illustrated with reference to FIGS. 5 and 6. FIG. 6 schematically illustrates the architecture of a digital media playing system according to the second embodiment of the present invention.

The digital media playing system 3 at least comprises a digital media server 21 and a digital media output device 32 that comply with the DLNA protocol. In this embodiment, the digital media output device 22 is a digital media render (DMR). That is, the digital media player used in the digital media playing system of the first embodiment is replaced by the digital media render of the digital media playing system of this embodiment. The digital media render is used for playing files only.

In the step (A), a user interface Y of the digital media server 21 is acquired. A device list is shown on the user interface Y. The device list includes all of the digital media output devices 32 that are now included in the same network domain and comply with the DLNA protocol. Then, the user may select the specified digital media output device 32 from the device list, so that the video and audio data of the digital media server 21 may be outputted to the digital media output device 32 through mirroring.

The digital media server 21 is for example a network-attached storage (NAS) device, a computer, a home theater device or a mobile phone that complies with the DLNA protocol. In this embodiment, the digital media server 21 is a NAS device. The digital media output device 32 (i.e. the digital media render) is for example a TV or a television speaker that complies with the DLNA protocol. In this embodiment, the digital media output device 32 includes a TV and a television speaker. In this embodiment, by operating the digital media output device 32, the video and audio data that are being played by the display screen and the speaker of the NAS device 21 may be selected and outputted to the TV and the television speaker to be played through mirroring. Consequently, the operating screen, the movie screen or the game screen of the NAS device can be synchronously played by the TV and the television speaker.

The other steps (A), (B) and (C) are similar to those of the first embodiment, and are not redundantly described herein.

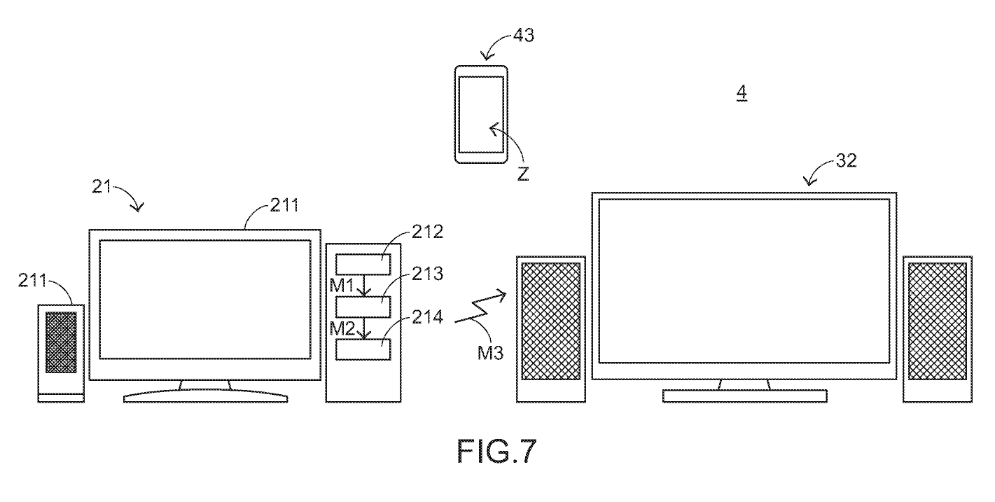

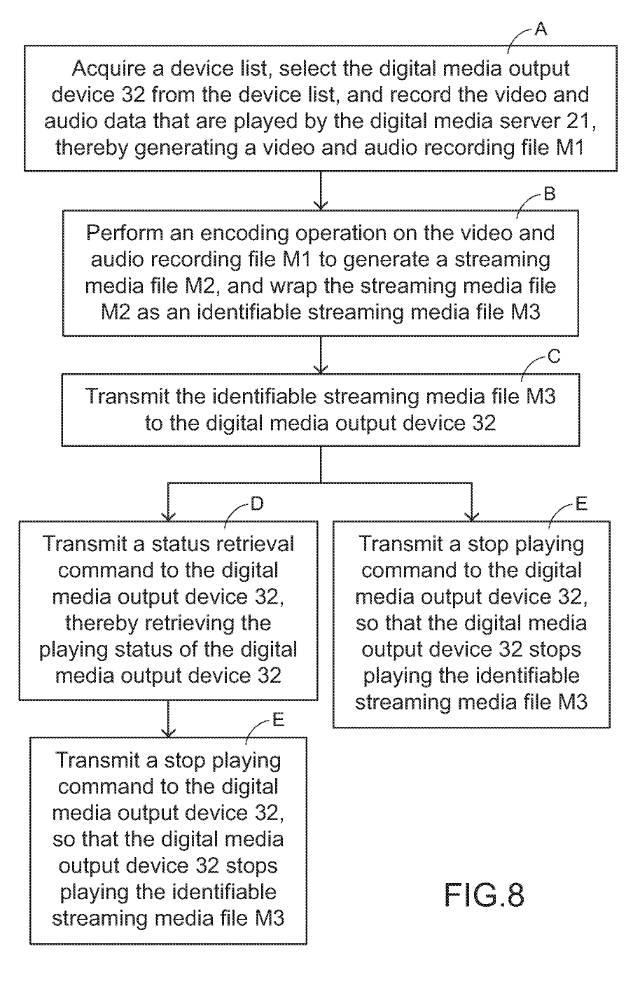

Hereinafter, a digital media playing system 4 according to a third embodiment of the present invention will be illustrated with reference to FIGS. 7 and 8. FIG. 7 schematically illustrates the architecture of a digital media playing system according to the third embodiment of the present invention. FIG. 8 is a flowchart illustrating a method of transmitting video and audio data by the digital media playing system according to the third embodiment of the present invention.

The digital media playing system 4 at least comprises a digital media server 21, a digital media output device 32 and a digital media controller (DMC) 43 that comply with the DLNA protocol. In this embodiment, the digital media output device 32 is a digital media render. In comparison with the first embodiment, the user interface that is operated by the user in the step (A) is the user interface Z of the digital media controller 43. A device list is shown on the user interface Z. The device list includes all of the digital media servers 21 and the digital media output devices 32 that are now included in the same network domain and comply with the DLNA protocol. The user may select the specified digital media server 21 and the specified digital media output device 32 from the device list, so that the video and audio data of the digital media server 21 may be outputted to the digital media output device 32 through mirroring.

The digital media server 21 is for example a network-attached storage (NAS) device, a computer, a home theater device or a mobile phone that complies with the DLNA protocol. In this embodiment, the digital media server 21 is a NAS device. The digital media output device 32 (i.e. the digital media render) is for example a TV or a television speaker that complies with the DLNA protocol. In this embodiment, the digital media output device 32 includes a TV and a television speaker. The digital media controller 43 is for example a remote controller, a PDA or a mobile phone that complies with the DLNA protocol. In this embodiment, the digital media controller 43 is a mobile phone. In this embodiment, by operating the mobile phone, the video and audio data that are being played by the display screen and the speaker of the NAS device 21 may be selected and outputted to the TV and the television speaker to be played through mirroring. Consequently, the operating screen, the movie screen or the game screen of the NAS device can be synchronously played by the TV and the television speaker.

The other steps (A), (B) and (C) are similar to those of the first embodiment, and are not redundantly described herein. Moreover, in comparison with the flowchart of FIG. 5, the flowchart of this embodiment further comprises steps (D) and (E). After the digital media output device 32 starts to play the identifiable streaming media file M3 (i.e. after the step (C)), the step (D) may be performed to transmit a status retrieval command from the digital media controller 43 to the digital media output device 32. After the status retrieval command is received by the digital media output device 32, the status retrieval command is sent back from the digital media output device 32 to the digital media controller 43. Consequently, the user can realize the playing status (e.g. the playing time or the playing speed) of the digital media output device 32.

Moreover, in the step (E), a stop playing command is transmitted from the digital media controller 43 to the digital media output device 32. After the stop playing command is received by the digital media output device 32, the digital media output device 32 stops playing the identifiable streaming media file M3. After the digital media output device 32 stops playing the identifiable streaming media file M3, the video and audio data that are being played by the video and audio playing device 211 are no longer recorded by the video and audio pickup device 212.

By the way, in the above embodiments, all of the digital media server, the digital media controller and the digital media output device transmit signals according to the DLNA protocol.

From the above descriptions, the present invention provides a digital media playing system. By recording the video and audio data that are played by a video and audio playing device of a digital media server, a video and audio recording file is generated. By performing an encoding operation and a wrapping operation on the video and audio recording file, an identifiable streaming media file is obtained. In addition, the identifiable streaming media file is transmitted to a digital media output device to be played. Consequently, the video and audio data that are played by the video and audio playing device of the digital media server can be outputted through mirroring. Under this circumstance, various products that are obtained from different manufacturers but comply with the DLNA protocol can achieve the mirroring function.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for outputting video and audio data that are played by a digital media server through mirroring, said method comprising steps of:
(A) recording said video and audio data that are played by said digital media server, thereby generating a video and audio recording file;
(B) converting said video and audio recording file into an identifiable streaming media file; and
(C) transmitting said identifiable streaming media file to a digital media output device.

2. The method according to claim 1, wherein said digital media output device is a digital media player or a digital media render.

3. The method according to claim 1, wherein said identifiable streaming media file contains a metadata, wherein according to said metadata, said identifiable streaming media file is identified and thus played by said digital media output device.

4. The method according to claim 1, wherein said digital media server comprises a video and audio playing device for playing said video and audio data.

5. The method according to claim 1, wherein in said step (A), said video and audio data that are played by said digital media server are recorded by a video and audio pickup device.

6. The method according to claim 1, wherein before said step (A) of recording said video and audio data, said method further comprises steps of:
acquiring a device list, wherein said device list at least includes said digital media output device; and
selecting said digital media output device from said device list.

7. The method according to claim 6, wherein said steps of acquiring said device list and selecting said digital media output device are performed by a digital media controller or said digital media output device or said digital media server.

8. The method according to claim 7, wherein all of said digital media server, said digital media controller and said digital media output device according to a Digital Living Network Alliance (DLNA) protocol.

9. The method according to claim 1, wherein said step (B) comprises sub-steps of:
performing an encoding operation on said video and audio recording file, thereby generating a streaming media file; and
wrapping said streaming media file as said identifiable streaming media file.

10. The method according to claim 1, wherein after said step (C), said method further comprises a step of transmitting a status retrieval command to said digital media output device, so that a playing status of said digital media output device is realized.

11. The method according to claim 1, wherein after said step (C), said method further comprises a step of transmitting a stop playing command to said digital media output device, wherein in response to said stop playing command, said digital media output device stops playing said identifiable streaming media file.

12. A digital media playing system, comprising:
a digital media server for playing video and audio data, recording said video and audio as a video and audio recording file and converting said video and audio recording file into an identifiable streaming media file; and
a digital media output device for receiving and playing said identifiable streaming media file.

13. The digital media playing system according to claim 12, wherein said digital media output device is a digital media player or a digital media render.

14. The digital media playing system according to claim 12, wherein said digital media server comprises:
a video and audio playing device for playing said video and audio data;
a video and audio pickup device for recording said video and audio as said video and audio recording file;
an encoder for performing an encoding operation on said video and audio recording file, thereby generating a streaming media file; and
a wrapper for wrapping said streaming media file as said identifiable streaming media file.

15. The digital media playing system according to claim 12, wherein said identifiable streaming media file contains a metadata, wherein according to said metadata, said identifiable streaming media file is identified and thus played by said digital media output device.

16. The digital media playing system according to claim 12,
wherein said digital media server or said digital media output device is permitted to acquire a device list and select said digital media output device from said device list, wherein said device list at least includes said digital media output device; or
wherein said digital media playing system further comprises a digital media controller for acquiring a device list and selecting said digital media output device from said device list, wherein said device list at least includes said digital media output device.

17. The digital media playing system according to claim 16, wherein all of said digital media server, said digital media controller and said digital media output device according to a Digital Living Network Alliance (DLNA) protocol.
